(19) United States
(12) Patent Application Publication
(10) Pub. No.: US 2003/0128659 A1
(43) Pub. Date: Jul. 10, 2003

(54) Coexistence of OFDM and DSSS/CCK stations in a WLAN

(75) Inventors: Olaf Josef Hirsch, Sunnyvale, CA (US); Atul Kumar Garg, San Jose, CA (US); Sunghyun Choi, Montvale, NJ (US); Abraham Jan de Bart, Nuenen (NL); Paul Gruijters, Best (NL)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/082,839

(22) Filed: Feb. 22, 2002

Related U.S. Application Data
(60) Provisional application No. 60/346,991, filed on Jan. 9, 2002.

(51) Int. Cl. H04J 11/00

(52) U.S. Cl. 370/208; 370/329

(57) ABSTRACT

A local area network is provided where OFDM stations and DSSS/CCK only stations coexist. Before transmitting, an OFDM station learns of the modulation capability of an intended receiving station. If the receiving station is only capable of DSSS/CCK modulation then the OFDM station transmits DSSS/CCK modulated data. If the receiving station is capable of OFDM modulation, then the OFDM station transmits OFDM modulated data thereby enabling efficient bandwidth usage.

### CROSS-REFERENCE TO RELATED APPLICATIONS

This application claims the benefit of U.S. Provisional Application No. 60/346991, filed Jan. 9, 2002.

### FIELD OF THE INVENTION

The invention pertains to wireless local area networks and to the coexistence of stations capable of different modulation schemes. The invention is particularly relevant to the coexistence and interoperability in a WLAN of stations capable of transmitting and receiving OFDM modulated data and stations capable of transmitting and receiving DSSS/CCK modulated data.

### BACKGROUND ART

The IEEE 802.11 WLAN standard provides a number of physical layer options in terms of data rates, modulation types and spreading spectrum technologies. An extension of the IEEE 802.11 standard, namely IEEE 802.11a, defines requirements for a physical layer operating in the 5 GHz U-NII frequency and data rates ranging from 6 Mps to 54 Mps. IEEE 802.11a defines a physical layer based on the orthogonal frequency division multiplexing (OFDM) modulation scheme. This physical layer is similar to the one defined by the European ETSI-HIPERLAN II (European Telecommunications Standards Institute-HiperLAN2). A second extension, IEEE 802.11b, defines a set of physical layers' specifications operating in the 2.4 GHz ISM frequency band up to 11 Mps. The direct sequence spread spectrum/complementary code keying (DSSS/CCK) physical layer is one of the three physical layers supported in the IEEE 802.11 standard and uses the 2.4 GHz frequency band as the RF transmission media.

The IEEE standard committee has created a working group TGg with the mission of developing a higher speed PHY extension to the 802.11b standard. The 802.11g standard will be compatible with the IEEE 802.11 MAC and will implement all mandatory portions of the IEEE 802.11b PHY standard. A scope of TGg is to provide a wireless LAN standard where stations communicating in OFDM modulation and legacy stations communicating in DSSS/CCK modulation coexist and communicate with each other.

Another extension IEEE 802.11e enhances the current 802.11 MAC to expand support for LAN applications with Quality of Service requirements. IEEE 802.11e enables direct communications from one station to another. Example applications include transport of voice, audio and video over 802.11 wireless networks, video conferencing, media stream distribution, enhanced security applications, and mobile and nomadic access applications.

### SUMMARY OF THE INVENTION

It is an object of the invention to enable the coexistence of OFDM stations and legacy DSSS/CCK stations in an IEEE 802.11 WLAN.

It is another object of the invention to provide a bandwidth efficient local area network, which optimizes the use of OFDM modulation.

To this end, a local area network of the invention comprises at least one OFDM station capable of transmitting and receiving OFDM and DSSS/CCK modulated data. The network also comprises another station, with which the OFDM station seeks to communicate. The OFDM station learns of the modulation capability of the intended receiving station. Upon learning, the OFDM station transmits OFDM modulated data to the receiving station if the receiving station is capable of OFDM modulation and transmits DSSS/CCK modulated data if the receiving station cannot decode OFDM modulation.

The receiving station may not be capable of decoding OFDM modulated data and as a result the receiving station needs to receive DSSS/CCK modulated data. However if the intended receiving station is OFDM-enabled the inventors have realized that the OFDM modulation should be used instead of using the slower DSSS/CCK modulation. Thus, the OFDM station, which is capable of both OFDM and DSSS/CCK modulations, learns of the modulation capabilities of the station it desires to communicate with. This knowledge permits the OFDM station to use the appropriate modulation scheme thereby enabling to increase the data rate. An advantage of the invention is to enable a more efficient use of the network bandwidth by enabling OFDM modulation for communications amongst OFDM stations.

In an embodiment of the invention, the network comprises an access point, which gathers the knowledge of the respective modulation capabilities of one or more stations in the network. The access point shares this knowledge with the OFDM station and informs the OFDM station of the modulation capability of the receiving station. The access point may have acquired such knowledge with respect to a given station when that station joined the network. For example, when joining the network, the new station transmits to the access point an information field indicating the OFDM capability.

The OFDM station may learn of the modulation capability of another station in the network from the access point when the OFDM station joins the network during an exchange of quests and probes with the access point.

In another embodiment, the OFDM station may learn of the modulation capability of the intended receiving station by detecting a frame exchanged by the receiving station. The OFDM station listens to the wireless medium and may detect frames received by or transmitted by the intended receiving station. By analyzing these frames, the OFDM station may know whether the receiving station is OFDM-capable or not.

In another embodiment of the invention the OFDM station is an access point. An advantage of this embodiment is to enable the access point of transmitting OFDM modulated data to OFDM stations thereby improving the bandwidth efficiency of the network as compared with a network where the access point only transmits DSSS/CCK modulated frames.

Alternatively, the OFDM station may also learn of the modulation of the station it desires to communicate with in a transmission opportunity transmitted by the access point. Indeed, when polling the OFDM station, the access point transmits a transmission opportunity indicating to the OFDM station the modulation schemes that the receiving station understands. The access point also sends a contention-free poll with transmission opportunity so that the surrounding stations understsnd the parameters of the transmission opportunity.

The invention also relates to an access point and a station in such a network.

### BRIEF DESCRIPTION OF THE DRAWING

The invention is explained in further details, by way of examples, and with reference to the accompanying drawing wherein:

FIG. 1 shows a wireless local area network of the invention;

FIG. 2 is a timing diagram showing communication periods in a wireless local area network;

FIG. 3 is a timing diagram showing communication periods of the invention;

FIG. 4 shows request-to-send and clear-to-send frames of the invention;

FIG. 5 shows dynamic adjustments of the sub-contention period and of the contention period; and

FIG. 6 is a local area network of the invention illustrating an OFDM station seeking to communicate with other stations in the network.

Elements within the drawing having similar or corresponding features are identified by like reference numerals.

### DETAILED DESCRIPTION

An 802.11 wireless local area network 100 of the invention as shown in FIG. 1 comprises an access point AP and a plurality of stations STA1-STA6. A station STA may communicate with another station directly as described in the IEEE 802.11e extension or a station STA may communicate with another station STA via the access point AP or the station STA may communicate with the access point AP only. The IEEE 802.11 specification describes two access mechanisms to the wireless medium by the stations STA1-STA6: the distributed coordination function and the point coordination function. The distributed coordination function access mechanism is shortly explained hereinafter.

The point coordination function is a centrally controlled access mechanism and a point coordinator located in the access point AP controls the access of the stations STA1-STA6 to the medium. The stations STA1-STA6 request that the point coordinator or access point AP registers them on a polling list. The access point AP regularly polls the stations STA1-STA6 for traffic information and data to be transmitted while also transmitting data to the stations STA1-STA6. The access point AP begins a period of operation called the contention-free period CFP, as shown in FIG. 2, during which the point coordination function is operating. During this contention-free period CFP, access to the medium is completely controlled by the access point AP. The contention-free period CFP occurs periodically to provide a near-isochronous service to the stations STA1-STA6. The IEEE 802.11 specification also defines a contention period CP alternating with the contention-free period CFP during which the distributed coordination function rules operate and all stations may compete for access to the medium as will be explained hereinafter.

FIG. 2 is a timing diagram 200 showing a contention-free period CFP followed by a contention period CP. The contention-free period CFP begins when the access point AP gains access to the medium during a previous contention period CP using the distributed coordination function procedures. Upon gaining access to the wireless medium, the access point AP transmits a beacon frame BF. The transmission of the beacon frame BF may be periodical, however the transmission of the beacon frame BF may be slightly delayed from an ideal start instant since the access point AP must compete for the medium according to the distributed coordination function rules.

During the contention-free period CFP, the access point AP has control of the medium and delivers traffic to stations STA1-STA6 and may poll stations STA1-STA6 that have requested content-free service for them to deliver traffic to the access point AP or to another station STA in the network. As a result, the traffic in the contention-free period CFP comprises frames sent from the access point AP to one or more of the stations STA1-STA6 followed by the acknowledgment from those stations. Every station STA may receive frames addressed to it by the access point AP and return an acknowledgment. The access point AP sends a contention-free poll (CF-Poll) frame to those stations STA1-STA6 that have requested contention-free service. If the station STA polled has traffic to send, it may transmit one frame for each contention-free poll CF-Poll received. If the station STA has no traffic to send, it may decide not to respond to the contention-free poll CF-Poll. The access point AP may send the contention-free poll CF-Poll addressed to a station together with data to be transmitted to that station.

The primary mechanism for preventing stations from accessing the medium during the contention-free period CFP is the network allocation vector (NAV) implemented by the IEEE 802.11 MAC. The NAV is a value that indicates to a station STA the amount of time that remains before the medium will become available. The NAV may be kept current in a station through duration values that are transmitted in all frames. The beacon frame BF sent by the access point AP at the beginning of the contention-free period CFP may contain information from the access point AP about the maximum expected length of the contention-free period CFP. A station STA receiving the beacon frame BF will enter this information into its NAV and is thus prevented from independently accessing the medium until the contention-free period CFP concludes or until the access point AP specifies otherwise to the station STA.

In an embodiment of the invention, the system 100 comprises a first group of stations ST1-STA3 capable of transmitting and receiving DSSS/CCK modulated data and a second group of stations STA4-STA6 capable of transmitting and receiving OFDM modulated data. A station STA1-STA3 cannot understand OFDM modulated data received from/transmitted to one of the stations STA4-STA6. Thus, stations STA1-STA3, which cannot decode OFDM modulated data, may not be able to follow collision avoidance mechanism.

In this embodiment, the access point AP has acquired knowledge of the respective modulation capability of one or more stations STA of the system 100. As a result when the access point AP desires to communicate with one of the stations STA1-STA3, the access point AP transmits DSSS/CCK modulated frames. However, when the access point AP communicates with one of the stations STA4-STA6, the access point AP uses the OFDM modulation if the access point AP is aware, at the time of transmission, that the intended receiving station STA4-STA6 is OFDM-capable. If the access point AP has not learned of the modulation capability of the station STA4-STA6, it desires to communicate with, the access point AP uses the DSSS/CCK modulation by default.

The access point AP may learn of the modulation capability of a given station STA when the station STA joins the network. An information field comprising an element indicating the OFDM capability may be exchanged when the station STA joins the network. The information field may be exchanged during authentication of the station STA by the access point AP. An OFDM bit of the information field may be reserved for indicating OFDM capability of the station STA4-ST6. The access point AP may also learn of the modulation capability of a given station during an exchange of quests and probes when the station STA joins the network.

In an embodiment of the invention the system 100 is a wireless LAN based on the IEEE 802.11e specification. IEEE 802.11e also specifies another access mechanism referred to as the hybrid coordination function. The hybrid coordination function combines aspects of the distributed coordination function and the point coordination function to provide selective handling of the stations for the quality of service facility. A hybrid coordinator handles the hybrid coordination function. The hybrid coordinator operates both during the contention-free period CFP and the contention period CP. The hybrid coordinator performs bandwidth management including the allocation of transmission opportunities to the stations. In this embodiment, the hybrid coordinator is comprised in the access point AP.

When polling one of the stations STA4-STA6, the access point AP checks whether it has knowledge of the modulation capability of the station STA4-STA6. If the station STA4-STA6 is known as being OFDM capable, the access point AP may transmit a transmission opportunity TXOP as defined in the IEEE 802.11 specification together with OFDM modulated data. A transmission opportunity TXOP is an interval of time when one of the stations STA1-STA6 has the right to initiate transmissions onto the medium. During the contention-free period, the starting time and duration of the transmission opportunity is indicated in the frame header of the contention-free poll frame CF-Poll transmitted by the hybrid coordinator or access point AP.

The access point AP may indicate in the CF-Poll during the TXOP transmission opportunity the modulation capability of the station STA, with which the station STA4-STA6 desires to communicate with. Thus, by informing the polled station STA4-STA6 of the modulation capability of the intended receiving station STA, the access point AP renders possible OFDM modulated communications between two OFDM stations in the network instead of using the slower DSSS/CCK modulation scheme.

FIG. 6 illustrates such data exchange between the access point AP and the OFDM station STA4. In this embodiment, the station STA4 comprises a first communication unit 110 for receiving and transmitting OFDM modulated data and a second communication unit 120 for receiving and transmitting DSSS/CCK modulated data. The station STA4 also comprises a learning unit 130 for indicating the modulation capability of one or more other stations in the system 100. The learning unit 130 may comprise a lookup table indicating the respective modulation capabilies of the other stations in the network. The learning unit 130 may acquire the knowledge from the access point AP. Alternatively, the learning unit 130 may listen to the wireless medium and may detect communications exchanged by a specific station STA over the medium. Therefrom, the learning unit 130 may determine the modulation scheme used and, thus determined the modulation capability of the specific station STA. The learning unit 130 may be operably coupled to the communication units 110 and 120 to operate the appropriate modulation for the transmission or reception of data. In this embodiment, the access point AP has learned of the respective modulations of the six stations STA1-STA6 during their respective authentication.

In a first scenario the station STA4 desires to communicate with the station STA1 and the access point AP polls the station STA4 during the contention-free period CFP or outside the contention-free period so that the station STA4 may start communicating with the station STA1. In this scenario, the access point AP transmits an DSSS/CCK transmission opportunity TXOP1 to the station STA4. The transmission opportunity TXOP1 or the contention-free poll sent by the access point AP comprises information indicating to the station STA4 that the station STA1 does not understand OFDM modulated data. The learning unit 130 is configured to understand such information and controls the communication unit 120 to transmit data. As a result, the communication unit 120 transmits DSSS/CCK modulated data 140 to the station STA1.

In another scenario the station STA4 desires to communicate with the station STA5 and the access point AP polls the station STA4 during the contention-free period CFP 310 so that the station STA4 may start communicating with the station STA5. In this scenario, the access point AP transmits a DSSS/CCK modulated transmission opportunity TXOP2 to the station STA4. The transmission opportunity TXOP2 or the contention-free poll CF-Poll sent by the access point AP comprises information indicating to the station STA4 that the station STA1 is capable of OFDM modulation. The learning unit 130 is configured to understand such information. As a result, the communication unit 120 transmits OFDM modulated data 150 to the station STA5.

In another embodiment, the access point AP shares the knowledge of the modulation capabilities of all stations STA in the network so that each station STA knows of the modulation capabilities of the other stations in the system 100. The access point AP may also share such knowledge with the OFDM stations STA4-STA6.

During the contention period CP, the basic access mechanism is the distributed coordination function, which uses carrier sense multiple access with collision avoidance. The stations STA1-STA6 sense the medium to see if it is already carrying a transmission. A station STA having its NAV set at zero waits until the medium is idle to start transmitting. The station STA can also do virtual carrier sensing by transmitting a request-to-send frame RTS to the intended receiver, the access point AP or another station STA, and by waiting for a clear-to-send frame CTS from the intended receiver. The RTS frame advertises the duration of the intended transmission and the duration may also be transmitted in the CTS frame. In some embodiments, the use of the RTS-CTS frames entails extra overhead and the mechanism may be dropped for smaller packets communication, using them only for larger packets.

In order to provide even higher data throughput, the system 100 may allocate a period of time to OFDM data transfer only.

A timing diagram of how the system 100 operates in another embodiment of the invention is given in FIG. 3. The access point AP initiates a contention-free period CFP by transmitting a beacon frame BF to the stations STA1-STA6. The contention-free period CFP is followed by a contention period CP. The contention-free period CFP consists of a first sub-part, a CCK/OFDM contention-free period 310 and a second sub-part, an OFDM contention period 320. In this embodiment, the CCK/OFDM contention-free period 310 occurs before the OFDM contention period 320 however this order may be inversed.

The location and/or duration of the OFDM contention period 320 may be transmitted in an information element of the beacon frame BF.

During the period 310, the CCK stations STA1-STA3 and the OFDM stations STA4-STA6 communicate with the access point AP when polled by the access point AP as mentioned above. In this embodiment, the access point AP may have been made aware of the OFDM capability of the stations STA4-STA6. Thus, when the access point AP polls or needs to access to a station STA during the contention-free period 310, it will access it using DSSS/CCK or OFDM modulation based on the known capabilities of the station STA. The station STA may then respond to the access point AP using the same modulation as it was addressed with. In one embodiment of the invention, the access point AP converts received OFDM (or DSSS/CCK) modulated data into DSSS/CCK (or OFDM respectively) modulated data for transmission to the receiving station based on respective capabilities of the transmitting and receiving stations.

During the period 320, a CCK station STA1-STA3 communicates with the access point AP when polled by the access point AP. In this embodiment, the access point AP is configured not to poll the stations STA1-STA3 during the period 320 and as a result, the stations STA1-STA3 may not transmit data during the period 320. During this period 320, the OFDM stations STA4-STA6 communicate with each other or with the access point AP based on a distributed coordination function. Such an OFDM contention period 320 enables to load the medium with pure OFDM data traffic and thereby enables high data throughput.

As mentioned above, a station STA4-STA6 gains access to the medium during the period 320 by sending a request-to-send RTS frame to the intended receiver and waits to receive a clear-to-send CTS frame from the intended receiver to start transmitting. In this embodiment, only OFDM stations may communicate during the period 320. As a result, the RTS and CTS frames are not necessarily modulated using DSSS/CCK modulation and may instead be OFDM modulated thereby enabling to reduce the data overhead and to improve the bandwidth efficiency.

The contention-free period CFP is then followed by the contention period 330. During period 330, both the legacy devices STA1-STA3 and the OFDM devices STA4-STA6 may compete for the medium and transmit data. Alternatively, only the legacy devices STA1-STA3 may communicate during the contention period 330.

In one embodiment of the invention, the stations STA1-STA6 may transmit DSSS/CCK modulated data only. The stations STA4-STA6 then need to send DSSS/CCK modulated RTS and CTS frames.

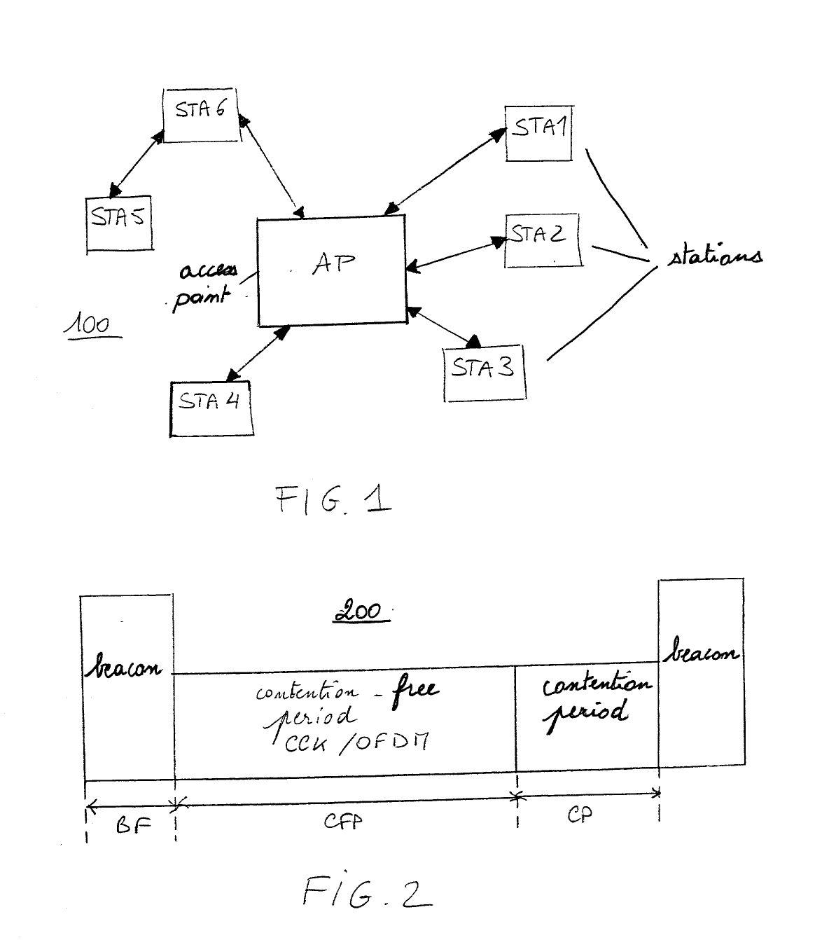

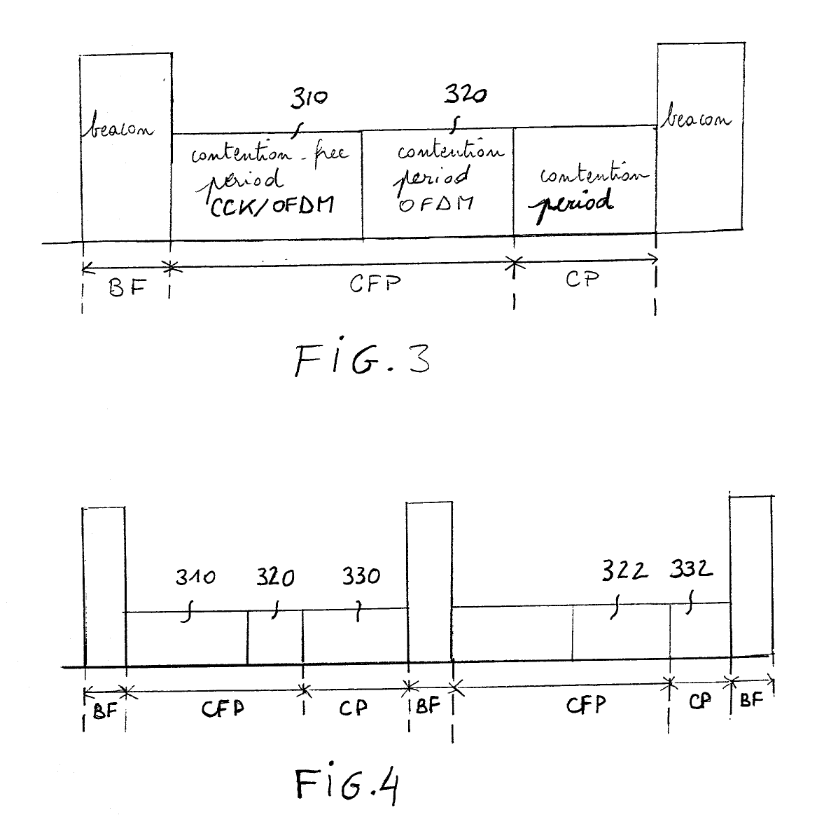

In another embodiment, the stations STA4-STA6 may communicate using either the CCK modulation or the OFDM modulation. Thus, alternative RTSA and CTSA frames are introduced as shown in FIG. 4. If one of the OFDM station STA4-STA6 or the access point AP desires to transmit OFDM data during the contention period 330, it may transmit such alternative RTSA frame that comprises a field indicating that OFDM modulated data is or will be transmitted. This alternative RTSA frame informs the receiving station that OFDM modulation could be used instead of DSSS/CCK. For example, one of the OFDM stations STA4-STA6 or the access point AP sends a request-to-send frame RTSA including an element which requests the receiving station to use either OFDM or DSSS/CCK modulation for the data transfer. The RTSA frame is modulated in DSSS/CCK. The receiving station then in its clear-to-send CTSA frame indicates whether it accepts or refuses the OFDM modulation. If the receiving station refuses the OFDM modulation, the access point AP or the station STA4-STA6 uses the DSSS/CCK modulation. If the station accepts the OFDM modulation and the access point AP or the station STA4-STA6 transmits OFDM modulated data.

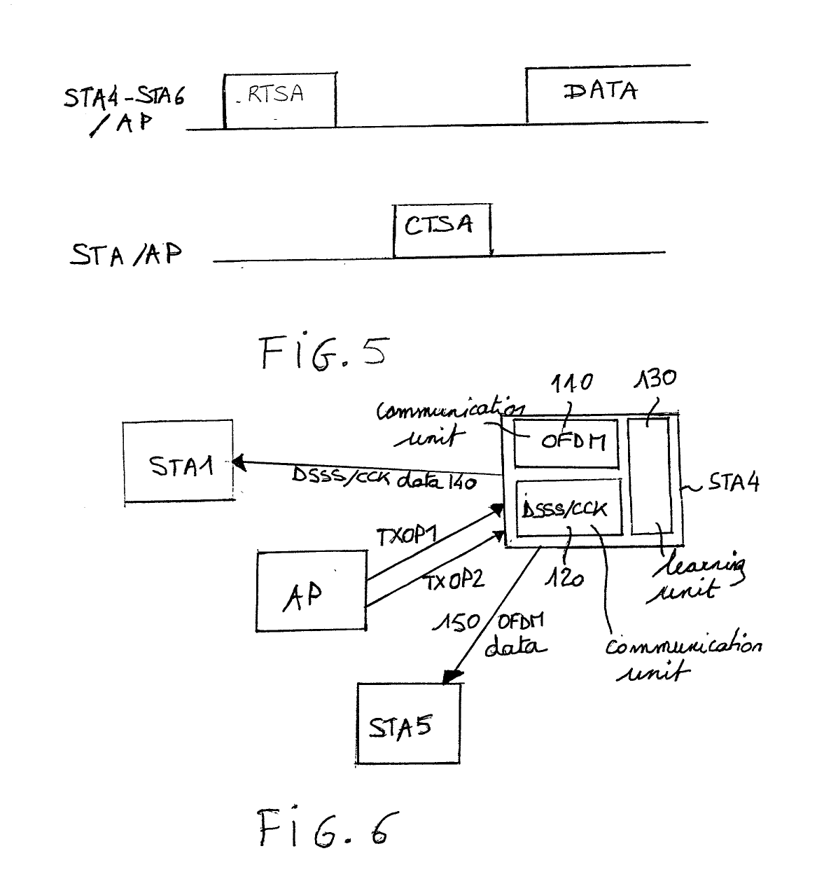

In another embodiment of the invention, the access point AP dynamically adjusts the duration of the contention period 320 based on the respective bandwidth requirements of the OFDM stations STA4-STA6. Thus, the more bandwidth is required from the stations STA4-STA6 relative to the stations STA1-STA3, the longest the contention period 320 may be. Alternately, the access point AP may also adjust the duration of the contention period 320 based on the number of stations capable of OFDM modulation. In case the number of OFDM stations STA is high relative to the total number of stations in the network, the access point AP will increase the duration of the contention period 320. FIG. 5 shows a dynamic adjustment of the sub-contention period 320 to the sub-contention period 322 and a dynamic adjustment of the contention period 330 to the contention period 332.

1. A wireless local area network comprising:
at least one OFDM station capable of transmitting and receiving OFDM and DSSS/CCK modulated data; and
an intended receiving station;
wherein, the OFDM station learns of the modulation capability of the intended receiving station and transmits OFDM modulated data if the receiving station is capable of OFDM modulation and transmits DSSS/CCK modulated data if the receiving station cannot decode OFDM modulation.

2. The local area network of claim 1, wherein the OFDM station learns of the modulation capability of the receiving station when the OFDM station joins the network.

3. The local area network of claim 1, wherein the OFDM station is an access point of the network.

4. The local area network of claim 1, wherein the OFDM station learns of the respective modulation capabilities of all other stations present in the network when the OFDM station joins the network.

5. The local area network of claim 1, wherein the OFDM station learns of the modulation capability of the receiving station upon detection of a previous frame exchanged over the network by the receiving station.

6. The local area network of claim 1 further comprising an access point for communicating with the stations and wherein the access point informs the OFDM station of the modulation capability of the receiving station.

7. The local area network of claim 6, wherein the access point informs the OFDM station in a transmission opportunity transmitted to the OFDM station.

8. The local area network of claim 1 further comprising an access point for communicating with the stations and, wherein the OFDM station informs the access point of its OFDM modulation capability during authentication of the OFDM station.

9. The local area network of claim 1, wherein the OFDM station transmits a request-to-send frame comprising information representative of the OFDM modulation capability and receives a clear-to-send frame from the receiving station indicating an acceptance of the OFDM modulation.

10. The local area network of claim 1, wherein the OFDM station transmits OFDM modulated request-to-send and clear-to-send frames to OFDM capable stations of the network.

11. The local area network of claim 1, wherein the stations operate under the IEEE 802.11e specification.

12. The local area network of claim 1, wherein the stations operate under the IEEE 802.11g specification.

13. The local area network of claim 1, wherein the OFDM station transmits an OFDM modulated request-to-send frame to the receiving station if the receiving station is capable of OFDM modulation.

14. A station comprising:
a first communication arrangement for transmitting and receiving OFDM modulated data over a wireless local area network;
a second communication arrangement for transmitting and receiving DSSS/CCK modulated data over the wireless local area network; and,
means for learning of the modulation capability of a receiving station, the learning means being operably coupled to the first and second transmission means;
wherein the first communication arrangement transmits OFDM modulated data if the receiving station is capable of OFDM modulation and the second communication arrangement transmits DSSS/CCK modulated data if the receiving station cannot decode OFDM modulated data.

15. The station of claim 14, wherein the learning means learns of the modulation capability of the receiving station upon detection of a previous frame exchanged over the network by the receiving station.

16. The station of claim 14, wherein the second communication arrangement transmits a request-to-send frame comprising information representative of the OFDM modulation capability and receives a clear-to-send frame from the receiving station, the clear-to-send comprising an information element representative of an acceptance of the OFDM modulation.

17. The station of claim 14, wherein the station transmits OFDM modulated request-to-send and clear-to-send frames to the receiving station if the receiving station is capable of OFDM modulation.

18. An access point within a local area network of a plurality of stations, for communicating with a station over the network, wherein the access point learns of the modulation capability of the station and transmits OFDM modulated data to the station if the station is capable of OFDM modulation and transmits DSSS/CCK modulated data to the station if the station cannot decode OFDM modulated data.

19. The access point of claim 18, wherein the access point informs an OFDM station of the network of the modulation capability of another station with which the OFDM desires to communicate with.

20. The access point of claim 18, wherein the access point comprises an hybrid coordinator and transmits a DSSS/CCK modulated transmission opportunity to an OFDM station, the transmission opportunity comprising information representative of the modulation capability of a station, with which the OFDM station seeks to communicate.
